(19) United States
(12) Patent Application Publication
(10) Pub. No.: US 2022/0247831 A1
(43) Pub. Date: Aug. 4, 2022

(54) WIFI ROUTER BUFFERED DOWNLOAD

(71) Applicant: Lenovo (Singapore) Pte. Ltd., Singapore (SG)

(72) Inventors: Nathan J. Peterson, Oxford, NC (US); Russell Speight VanBlon, Raleigh, NC (US); Arnold S. Weksler, Raleigh, NC (US); Mark Patrick Delaney, Raleigh, NC (US); John Carl Mese, Cary, NC (US)

(21) Appl. No.: 17/165,609

(22) Filed: Feb. 2, 2021

(51) Int. Cl. H04L 29/08; H04L 29/12

(52) U.S. Cl. CPC H04L 67/2842; H04W 84/12; H04L 61/2015

(57) ABSTRACT

A computer implemented method includes receiving an indication from a user internet access device that the user internet access device supports user internet access device download management, The user device then generates a download request for a data download and sends the download request from the user device to the user internet access device. The user device is then disconnected. The internet access device continues downloading and storing the data while the user device is disconnected. In response to connecting of the user device, the data downloaded is received from the user internet access device.

### BACKGROUND

Downloading information to a device in a user's home can take a significant amount of time. The amount of time taken for downloads can vary depending on the amount of data in the download and the speed of the internet connection. More and more users are opting to use mobile laptops in their home rather than stationary desktop devices. Because of this, the users don't necessarily have their laptops plugged in all the time. Many laptops thus spend much of their time in suspend-mode sitting on a coffee table or elsewhere. Also, laptops default to suspend when their lids are closed. If a user starts a download that is going to take a long amount of time, the user must leave their laptop plugged in, lid open, and sitting in a possibly inconvenient location. Otherwise, the laptop may enter suspend mode and interrupt the download. Upon powering on the laptop, an error message may be found, the download may have to be initiated again.

### SUMMARY

A computer implemented method includes receiving an indication from a user internet access device that the user internet access device supports user internet access device download management, The user device then generates a download request for a data download and sends the download request from the user device to the user internet access device. The user device is then disconnected. The internet access device continues downloading and storing the data while the user device is disconnected. In response to connecting of the user device, the data downloaded is received from the user internet access device.

### BRIEF DESCRIPTION OF THE DRAWINGS

FIG. 1 is a block diagram of a system for managing downloads according to an example embodiment.

FIG. 2 is a flowchart illustrating a computer implemented method of downloading data using user network access device according to an example embodiment.

FIG. 3 is a timing diagram illustrating a method of buffering device requested downloads at a local network access device according to an example embodiment.

FIG. 4 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Nearly all home internet users have an internet access device such as a router or modem of some sort that is used to connect to the internet. Various user devices, such as laptop computers connect to a network, such as the Internet, to access data from, and communicate with, other devices coupled to the Internet or other networks.

The home routers are generally always on as compared to user devices which may not always be on, and hence not always able receive data from the Internet. User devices may enter various power conservation modes when not plugged in to a source of power. If the a user device enters a mode where the user device becomes disconnected from the router and is no longer able to receive data being downloaded, any such download may not successfully complete, and may need to be restarted, or otherwise resumed. Router to internet connection speeds may be relatively slow as compared to router to user device connections. For instance, DSL connections are fairly slow when compared to router to device connections, which may include a wired ethernet connection or a local wireless connection.

In various embodiments of the present inventive subject matter, a user requests a download of a batch of data. The user device instructs the router to downloaded the batch of data to the router whether or not the laptop stays on. In one example, a download is expected to take 1-2 hours based on the amount of data or size of one or more files and the connection speed of the router to the internet. The router may proceed to download the data to a storage location accessible to the router, which usually is always powered on and can thus receive the entire download without interruption.

The user may close a lid of the laptop putting the laptop into a suspend or sleep mode, during which communication with the router is interrupted causing the laptop to become disconnected from the router. Disconnection may also occur if a laptop moves out of range of the router. The user may come back and use the laptop at a later time or come back within range causing the laptop to connect again to the router. During the time of interrupted communication between the router and the user device, the router continues to download the data without interaction with the user device. Such continued downloading is said be performed in the background with respect to the user device.

In response to the laptop powering back on, the laptop receives an update regarding the download from the router as to the completion status of the download. If the download is complete, the data is sent to the laptop via a local network connection, which may be significantly faster that the router connection to the internet. In various embodiments, the downloaded data may be designated as only for the requesting user device. The user device may be identified by an IP address that the router provided the user device to ensure that the downloaded data is only sent to the requesting user device.

In various embodiments, a laptop service is used to generate a request to the router for the download. The request authorizes the router to make a request for download to an internet connected device such that the router appears to be making the request. The router handles all packet acknowledgements during the download such that the download continues until completion absent network problems or download server problems. Give such problems, the router may renew the request until the download is completed or deemed unavailable.

In another example, a user may initiate a request to start a download to a user device within range of the router, such as when the user device is at or near home. Once the request has been sent, the user may leave the house with the laptop. However, the router continues the download while the user device is unable to communicate with the router. Upon the user device coming back in range of the router, the download may be completed. Downloads may range from movies, large software updates, a new RedHat ISO, and others.

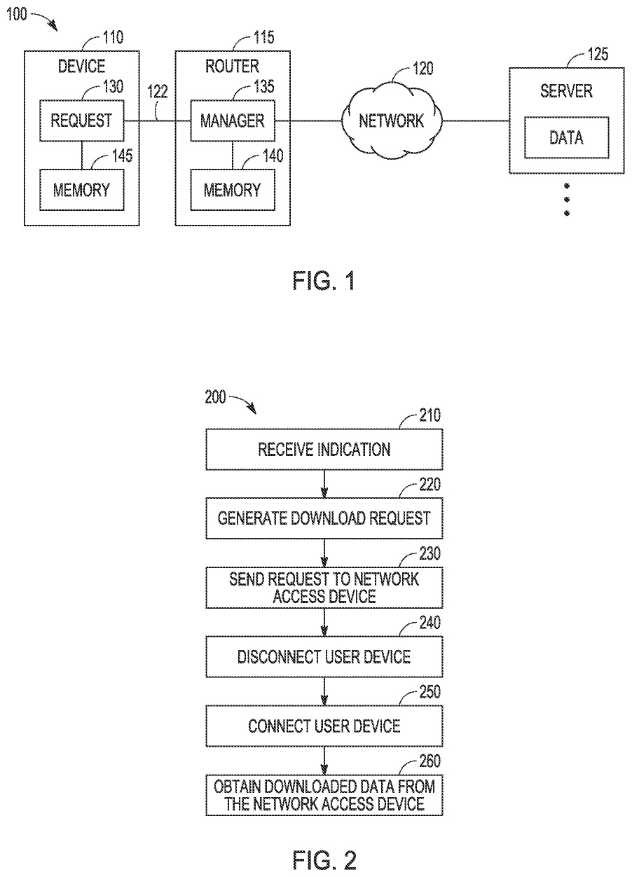

FIG. 1 is a block diagram of a system 100 for managing downloads. A user device 110 is a coupled to a user or user internet access device 115 that provides access to a network 120, such as the internet. Multiple servers 125 may be coupled to the network 120 and have various data that the user device may wish to obtain access to, such as movies, software, and other data stored in different files.

The user device 110 connection 122 to the user internet access device 115 may be wired or wireless, such as WiFi, connection. The user internet access device 115 may be coupled to the network 120 via a service such as digital subscriber link (DSL), telephone line, cable, or other service provider infrastructure, each of which may have varying data transfer speeds. In some cases, the data transfer speed between the network 120 and the user internet access device 115 is fairly slow such that downloads of data can take a significant amount of time.

In prior implementations, the user device 110 generates a request 130 and provides the request to the internet access device 115. The request is routed on to the server 125. As data packets are received from the server 125, the internet access device 115 simply passes on data packets as the packets are received, and the user device 110 provides an acknowledgement, which travels back to the server 125. A typical protocol for such a data transfer is referred to as transmission control protocol/Internet protocol (TCP/IP). If the user device 110 does not respond or otherwise provide an acknowledgment, the data transfer/download fails. This can happen in response to the user device 110 entering a suspend mode or otherwise disconnecting from the internet access device 115 during the data transfer. Another failure mode includes the user device 110 going out of range of the internet access device 115 wireless connection, or the wired connection becoming unplugged.

To avoid such download failure, the user internet access device 115 and the user device 110 negotiate via respective apps, also represented at 130 and 135 respectively to reach an understanding that the user internet access device 115 will act as the originator of the request 130 via a user internet access device data download manager 135, hereinafter manager 135. The manager 135 will provide the request to the server 125 and receive and store the received packets in memory 140, as well as provide acknowledgements such that the transfer completes. Note that most internet access devices are continuously operating, so there is a much smaller chance that the data transfer will become interrupted and fail.

On completion of the download, or sooner if the user device is still connected to the user internet access device 115, the packets will be transferred from memory 140 to user device memory 145. Note that if the user device 110 goes out of range or becomes suspended due to a user closing a screen of the user device, or the user device not receiving user input for a set amount of time, the data download between the user internet access device 115 and the server 125 does not fail. Upon the user device becoming active again, the transfer between memory 140 and user device memory 145 may resume, or even start over if interrupted in the middle of the transfer. Since the transfer rate over the connection 122 is comparatively high speed compared to some internet connections, it takes much less time to transfer the data between the respective memories, meaning that such data transfer is much less likely to be interrupted.

In some embodiments, the transfer between memory 140 and user device memory 145 may be monitored such that the transfer may be resumed when interrupted as opposed to restarted due to an interruption. Contrast this to the network 120 based data transfer, which may not accommodate such a data transfer resumption as opposed to failing and restarting. In some embodiments, even if the network data transfer was resumable, it is still beneficial to have the user internet access device 115 negotiate with the user device to manage the data transfer, since the data transfer can occur much more quickly from a memory 140 buffered already downloaded data file to the user memory device 145.

FIG. 2 is a flowchart illustrating a computer implemented method 200 of downloading data using user internet access device 115. A processing device executes operations including receiving, at operation 210, an indication from a user internet access device that the user internet access device supports user internet access device download management. The indication that user internet access device supports user internet access device download management may be received from the user internet access device 115 in response to a user device request for an IP address. In one embodiment, the user device request for an IP address comprises a Dynamic Host Configuration Protocol (DHCP) broadcast request.

The local network access device 115, such as a router has a “pool” of IP addresses that it keeps track of. When a user device connects to the user internet access device 115 and asks for an IP address, the user internet access device 115 picks an IP address from the pool and assigns it to the user device 110. The user internet access device 115 differs from the user device 110 in that the user internet access device 115 has at least two IP address: a public IP address and a private IP address. The public IP address of the router is visible on the Internet and is used to communicate with devices on the internet. The private IP address is used to communicate with user devices.

At operation 220, a download request for a data download is generated, such as in response to a user clicking on a link comprising an IP address identifying the location of the data. The location of the data may be on a server accessible via the internet.

The download request is sent at operation 230 from the user device to the user internet access device. The download request is associated with the user device via the user device IP address already assigned. The user internet access device then generates the download request using its public IP address and receives and saves the download designated for the user device.

After the user device download request is sent to the user internet access device at operation 230, the user device may become disconnected from the router by entering a suspended state or becoming out of range at operation 240, or other in a state where data corresponding to the request cannot be received by the user device. The disconnection may occur at any time following sending of the download request to the user internet access device and may also occur prior to the data download to the user internet access device completing.

At operation 250, the user device wakes up or otherwise comes within range, thus connecting with the router such that data corresponding to the download request can be received. At operation 260, in response to the user device waking up, data downloaded by the user internet access device while the user device was disconnected is obtained from the user internet access device. Optionally, at least a portion of the data download may be obtained from the user internet access device prior to suspending the user device and either resumed or restarted following the user device waking up. Alternatively, the data download may be obtained in an uninterrupted manner following completion of the download to the user internet access device.

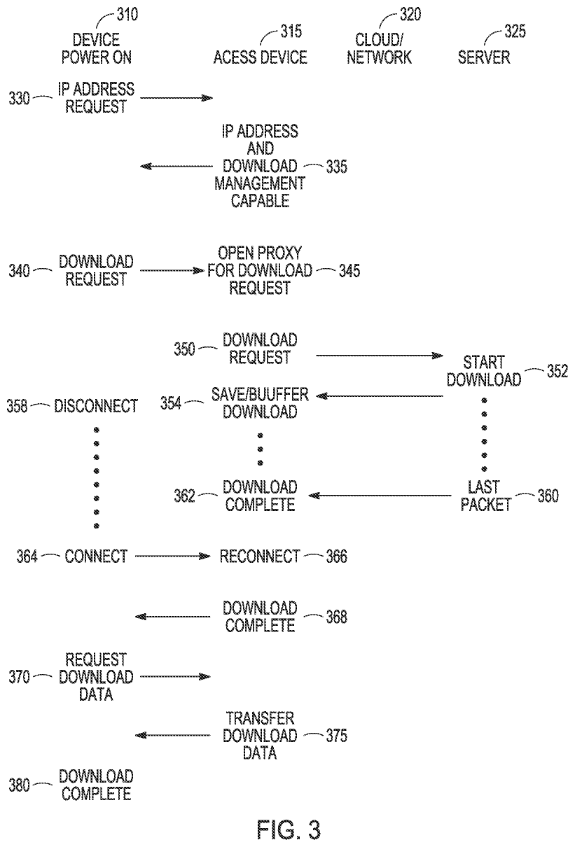

FIG. 3 is a timing diagram illustrating a method 300 of buffering device requested downloads at a local network access device. Timing of interactions between a user device 310, access device 315, network 320, and a server 325 are illustrated in corresponding columns. Time is represented by distance down the column from an initial device power on and address request communication at 330 from device 310 to access device 315. At 335, a user device IP address is assigned and sent to the device 310. Included is an indication that the access device is download management capable and will operate to store requested downloads either as a default or if requested.

At 340, a download request is generated and sent by device 310. The download request may include an IP address for the download and may also include an indication that access device management of the download request is desired. Device 310 may become disconnected from access device 315 after sending the request. On receipt of the download request, the access device 315 creates a new request at 350 using its public IP address and sends a TCP/IP request via network 320 to server 325.

Server 325 starts transferring TCP packets of the download to the access device 315 at 352. The access device 315 stores the packets at 354 in local storage. The local storage may be part of access device 315 or may be other storage locally accessible by access device 315 that is known to be available to accept the download without interruption. At 360, the last packet is sent by server 325 via network 320 to the access device 315 and stored, completing the download at 362.

At 364, the device 310 becomes awake or within range and able to connect to the access device 315 which reconnects at 366. At 368, the access device sends a download complete indication to the device 310. At 370, the access device may request the download data and at 375, the access device accesses the download data and transfers the download data to the device 310. The download is then completed at the device 310 at 380, satisfying the original download request from 340.

The access device 315 ensures that the download request is provided to the correct device 310 via the assigned IP address of the access device 315. The device may also specify either in the original download request at 340 or in the response at 370 to the download complete indication 368, where in device accessible storage the download data is to be stored, allowing the router to provide the data to the device 310 by placing the downloaded data into the specified storage.

In various embodiments, the downloaded data may also be provided by the access device 115 to the device 110 after the original request and prior to the device 110 becoming disconnected. If not complete prior to suspension, packets not acknowledged by the device 110 may be resent by the access device 115 once the device 110 becomes reconnected. Alternatively, the access device 115 may poll the device 110 to ensure the device is still awake and receiving data. Further alternatively include restarting the transfer of data stored by the access device 115 to the device 110 should the device 110 become suspended during a data transfer.

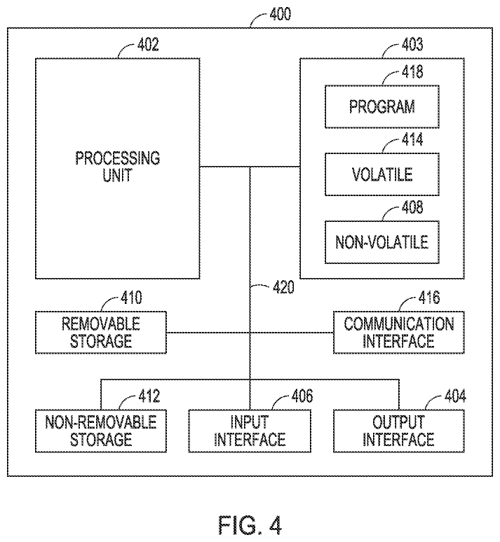

FIG. 4 is a block schematic diagram of a computer system 400 for implementing one or more devices, access devices, and servers and for processing download requests and executing apps that include methods and algorithms according to example embodiments. All components need not be used in various embodiments.

One example computing device in the form of a computer 400 may include a processing unit 402, memory 403, removable storage 410, and non-removable storage 412. Although the example computing device is illustrated and described as computer 400, the computing device may be in different forms in different embodiments. For example, the computing device may instead be a smartphone, a tablet, smartwatch, smart storage device (SSD), or other computing device including the same or similar elements as illustrated and described with regard to FIG. 4. Devices, such as smartphones, tablets, and smartwatches, are generally collectively referred to as mobile devices or user equipment.

Although the various data storage elements are illustrated as part of the computer 400, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 403 may include volatile memory 414 and non-volatile memory 408. Computer 400 may include—or have access to a computing environment that includes—a variety of computer-readable media, such as volatile memory 414 and non-volatile memory 408, removable storage 410 and non-removable storage 412. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 400 may include or have access to a computing environment that includes input interface 406, output interface 404, and a communication interface 416. Output interface 404 may include a display device, such as a touchscreen, that also may serve as an input device. The input interface 406 may include one or more of a touchscreen, touchpad, mouse, keyboard, camera, one or more device-specific buttons, one or more sensors integrated within or coupled via wired or wireless data connections to the computer 400, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 400 are connected with a system bus 420.

Computer-readable instructions stored on a computer-readable medium are executable by the processing unit 402 of the computer 400, such as a program 418. The program 418 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves to the extent carrier waves are deemed too transitory. Storage can also include networked storage, such as a storage area network (SAN). Computer program 418 along with the workspace manager 422 may be used to cause processing unit 402 to perform one or more methods or algorithms described herein.

### Examples

1. A computer implemented method includes receiving an indication from a user internet access device that the user internet access device supports user internet access device download management, generating a download request for a data download, sending the download request from the user device to the user internet access device, disconnecting from the user internet access device, and obtaining, from the user internet access device, the data download by the user internet access device while the user device was disconnected in response to the user device connecting.

2. The method of example 1 wherein disconnecting the user device includes suspending the user device or moving the user device out of range of the user internet access device prior to the data download to the user internet access device completing.

3. The method of any of examples 1-2 wherein the download request identifies a user device accessible storage location for obtaining the data download from the user internet access device.

4. The method of any of examples 1-3 wherein obtaining the data download includes obtaining at least a portion of the data download prior to disconnecting the user device.

5. The method of example 4 wherein obtaining the data download includes resuming the data download to obtain a remaining portion of the data download in response to the user device connecting.

6. The method of any of examples 1-5 wherein obtaining the download is performed in an uninterrupted manner.

7. The method of any of examples 1-6 wherein the indication that the user internet access device supports user internet access device download management is received from the user internet access device in response to a user device request for an IP address.

8. The method of example 7 wherein the user device request for an IP address comprises a Dynamic Host Configuration Protocol (DHCP) broadcast request.

9. A machine-readable storage device has instructions for execution by a processor of a machine to cause the processor to perform operations to perform a method. The operations include receiving an indication from a user internet access device that the user internet access device supports user internet access device download management, generating a download request for a data download, sending the download request from the user device to the user internet access device, disconnecting from the user internet access device, and obtaining, from the user internet access device, the data download by the user internet access device while the user device was disconnected in response to the user device connecting.

10. The device of example 9 wherein disconnecting the user device includes suspending the user device or moving the user device out of range of the user internet access device prior to the data download to the user internet access device completing.

11. The device of any of examples 9-10 wherein the download request identifies a user device accessible storage location for obtaining the data download from the user internet access device.

12. The device of any of examples 9-11 wherein obtaining the data download includes obtaining at least a portion of the data download prior to disconnecting the user device.

13. The device of example 12 wherein obtaining the data download includes resuming the data download to obtain a remaining portion of the data download in response to the user device connecting.

14. The device of any of examples 9-13 wherein obtaining the download is performed in an uninterrupted manner.

15. The device of any of examples 9-14 wherein the indication that the user internet access device supports user internet access device download management is received from the user internet access device in response to a user device request for an IP address.

16. The device of example 15 wherein the user device request for an IP address comprises a Dynamic Host Configuration Protocol (DHCP) broadcast request.

17. A device includes a processor and a memory device coupled to the processor and having a program stored thereon for execution by the processor to perform operations. The operations include receiving an indication from a user internet access device that the user internet access device supports user internet access device download management, generating a download request for a data download, sending the download request from the user device to the user internet access device, disconnecting from the user internet access device, and obtaining, from the user internet access device, the data download by the user internet access device while the user device was disconnected in response to the user device connecting.

18. The device of example 17 wherein disconnecting the user device includes suspending the user device or moving the user device out of range of the user internet access device prior to the data download to the user internet access device completing.

19. The device of any of examples 17-18 wherein the download request identifies a user device accessible storage location for obtaining the data download from the user internet access device.

20. The device of any of examples 17-19 wherein obtaining the data download includes operations of obtaining at least a portion of the data download prior to disconnecting the user device and resuming the data download to obtain a remaining portion of the data download in response to the user device connecting.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving an indication from a user internet access device that the user internet access device supports user internet access device download management;
generating a download request for a data download;
sending the download request from the user device to the user internet access device;
disconnecting from the user internet access device; and
obtaining, from the user internet access device, the data download by the user internet access device while the user device was disconnected in response to the user device connecting.

2. The method of claim 1 wherein disconnecting the user device includes suspending the user device or moving the user device out of range of the user internet access device prior to the data download to the user internet access device completing.

3. The method of claim 1 wherein the download request identifies a user device accessible storage location for obtaining the data download from the user internet access device.

4. The method of claim 1 wherein obtaining the data download includes obtaining at least a portion of the data download prior to disconnecting the user device.

5. The method of claim 4 wherein obtaining the data download includes resuming the data download to obtain a remaining portion of the data download in response to the user device connecting.

6. The method of claim 1 wherein obtaining the download is performed in an uninterrupted manner.

7. The method of claim 1 wherein the indication that the user internet access device supports user internet access device download management is received from the user internet access device in response to a user device request for an IP address.

8. The method of claim 7 wherein the user device request for an IP address comprises a Dynamic Host Configuration Protocol (DHCP) broadcast request.

9. A machine-readable storage device having instructions for execution by a processor of a machine to cause the processor to perform operations to perform a method, the operations comprising:
receiving an indication from a user internet access device that the user internet access device supports user internet access device download management;
generating a download request for a data download;
sending the download request from the user device to the user internet access device;
disconnecting from the user internet access device; and
obtaining, from the user internet access device, the data download by the user internet access device while the user device was disconnected in response to the user device connecting.

10. The device of claim 9 wherein disconnecting the user device includes suspending the user device or moving the user device out of range of the user internet access device prior to the data download to the user internet access device completing.

11. The device of claim 9 wherein the download request identifies a user device accessible storage location for obtaining the data download from the user internet access device.

12. The device of claim 9 wherein obtaining the data download includes obtaining at least a portion of the data download prior to disconnecting the user device.

13. The device of claim 12 wherein obtaining the data download includes resuming the data download to obtain a remaining portion of the data download in response to the user device connecting.

14. The device of claim 9 wherein obtaining the download is performed in an uninterrupted manner.

15. The device of claim 9 wherein the indication that the user internet access device supports user internet access device download management is received from the user internet access device in response to a user device request for an IP address.

16. The device of claim 15 wherein the user device request for an IP address comprises a Dynamic Host Configuration Protocol (DHCP) broadcast request.

17. A device comprising:
a processor; and
a memory device coupled to the processor and having a program stored thereon for execution by the processor to perform operations comprising:
receiving an indication from a user internet access device that the user internet access device supports user internet access device download management;
generating a download request for a data download;
sending the download request from the user device to the user internet access device;
disconnecting from the user internet access device; and
obtaining, from the user internet access device, the data download by the user internet access device while the user device was disconnected in response to the user device connecting.

18. The device of claim 17 wherein disconnecting the user device includes suspending the user device or moving the user device out of range of the user internet access device prior to the data download to the user internet access device completing.

19. The device of claim 17 wherein the download request identifies a user device accessible storage location for obtaining the data download from the user internet access device.

20. The device of claim 17 wherein obtaining the data download includes operations comprising:
obtaining at least a portion of the data download prior to disconnecting the user device; and
resuming the data download to obtain a remaining portion of the data download in response to the user device connecting.
